(19) United States
(12) Patent Application Publication
(10) Pub. No.: US 2026/0250472 A1
(43) Pub. Date: Aug. 27, 2026

(54) METHOD FOR PREPARING RUBBER COMPOSITE MATERIAL

(71) Applicant: Inner Mongolia University of Technology, Hohhot City (CN)

(72) Inventors: Yinmin ZHANG, Hohhot City (CN); Xianggang FENG, Hohhot City (CN); Yongfeng ZHANG, Hohhot City (CN); Weijiang WANG, Hohhot City (CN)

(21) Appl. No.: 19/239,273

(22) Filed: Jun. 16, 2025

(30) Foreign Application Priority Data
Feb. 26, 2025 (CN) 202510214453.2

(51) Int. Cl. C08J 3/215; C08K 3/30; C08K 11/00

(52) U.S. Cl. CPC C08J 3/215; C08K 3/30; C08K 11/005; C08J 2307/02; C08K 2003/3081; C08K 2201/005

(57) ABSTRACT

Provided is a method for preparing a rubber composite material. The method includes: subjecting a flocculated coal gasification black water solution to concentration to obtain a concentrated solution, mixing the concentrated solution and a dispersant, and subjecting a resulting mixture to attrition and magnetic separation in sequence to obtain a magnetically separated suspension; adjusting the magnetically separated suspension to be alkaline, and subjecting a resulting system to aging and sieving in sequence to obtain a refined slurry; and mixing the refined slurry, a rubber emulsion, and a flocculant and conducting flocculation copolymerization to obtain the rubber composite material.

### CROSS REFERENCE TO RELATED APPLICATION

This patent application claims the benefit and priority of Chinese Patent Application No. 2025102144532 filed with the China National Intellectual Property Administration on Feb. 26, 2025, the disclosure of which is incorporated by reference herein in its entirety as part of the present application.

### TECHNICAL FIELD

The present disclosure belongs to the technical field of rubber materials, and in particular relates to a method for preparing a rubber composite material.

### BACKGROUND

China is a leading coal resource country, with coal production contributing over 50% of the global total. Coal occupies a dominant position in China's energy structure. With the accelerated transition of China's energy consumption structure towards clean and low-carbon energy, the clean and efficient utilization of coal has become an irresistible trend. Currently, coal gasification has become one of the key development directions for the clean and efficient utilization of coal, which meets China's industrial requirements for green, low-carbon, and high-quality development.

In the process of coal gasification, most of the carbonaceous components in coal are converted into gas, while the associated inorganic minerals, non-gasifiable carbonaceous matter, catalysts, etc., in the raw coal are discharged as residues, known as coal gasification slag. Research and analysis results show that approximately 15% to 20% of coal is converted into gasification slag during the gasification process. At present, the coal gasification slag has a low comprehensive utilization rate and is still mainly landfilled and stored in the open air. The long-term storage of vast amounts of gasification ash residues pollutes the soil/water system and the atmospheric environment, severely threatening the safety of the ecological environment. The comprehensive treatment of coal gasification slag is a major barrier to achieving green, low-carbon, and sustainable practices in the coal chemical industry. Currently, the comprehensive utilization of coal gasification slag mainly focuses on coal gasification fine slag, and the application research mainly focuses on fields such as carbon component recovery, building materials, soil improvement, water pollution control, etc. However, there have been no large-scale, systematic, and full-component-utilized industrial utilization cases of coal gasification slag.

In the coal gasification process, the mineral components in coal are converted into molten slag. A portion of the molten slag is carried away by the gas flow, sent to the subsequent purification process, and eventually discharged with black water into the ash water treatment system, forming a flocculated coal gasification black water solution. The black water flocculation liquid is pumped and then dewatered to form fine slag with relatively small particle sizes, known as coal gasification fine slag. Coal gasification fine slag features high water content, mixed residual carbon and inorganic components, notable compositional variability, and dewatering challenges. Moreover, the carbon and ash components mutually constrain each other, limiting the resource utilization of coal gasification fine slag. The carbonaceous components and inorganic silico-aluminous glassy components in coal gasification fine slag form a typical carbon-silicon hybrid materials, which exhibit stable physical and chemical properties, suitable specific surface area, and high-temperature resistance and can be used as compounding fillers for polymer composite materials after appropriate treatment.

Prior art discloses a method for preparing a rubber filler using coal gasification slag as a raw material. This method involves subjecting coal gasification fine slag to drying, magnetic separation, activation, ultra-fine grinding, and surface modification to prepare a rubber filler powder. Other prior art also disclose a rubber filler made from coal gasification fine slag as a raw material, a preparation method and use thereof. The process involves removing residual carbon from the coal gasification fine slag, and leaching out metal oxides through acid dissolution to obtain a mesoporous silica-based filler. Additionally, prior art also discloses a method for preparing a rubber/plastic filler, a rubber/plastic filler, and use thereof. The method involves adding water to coal gasification fine slag for pulping, and collecting a silicon-rich composite slurry by gravity cyclone, then subjecting the silicon-rich composite slurry to solid-liquid separation and drying to obtain the rubber/plastic filler.

In the prior art, coal gasification fine slag samples are typically collected from coal gasification fine slag stockpiles, and then subjected to a series of processing steps to produce a polymer composite material article. The process flow is lengthy and complicated. The processing of gasification fine slag requires acid treatment, which is prone to producing acidic wastewater, leading to environmental pollution. During processing, it is necessary to dry the coal gasification fine slag. However, since the coal gasification fine slag has characteristics such as high water content and difficult dewatering, it would cause high production energy consumption. In addition, in the prior art, the coal gasification fine slag is generally prepared into a filler powder, which requires additional processing with raw rubber and fails to integrate the functional treatment of coal gasification fine slag with the preparation of rubber materials, resulting in a complex and lengthy application process for using coal gasification fine slag in rubber/plastic composite materials.

Therefore, there is an urgent need for a treatment technology characterized by a simplified process flow, being water-saving and environmentally friendly, and low energy consumption.

### SUMMARY

Based on the carbon-inorganic component silicon composite structure in the flocculated coal gasification black water solution, an object of the present disclosure is to provide a method for preparing a rubber composite material using the carbon-inorganic components in the flocculated coal gasification black water solution. The method provided by the present disclosure shows a simplified process flow, being water-saving and environmentally friendly, and low energy consumption.

To achieve the object described above, the present disclosure provides the following technical solutions.

The present disclosure provides a method for preparing a rubber composite material, including the following steps:
subjecting a flocculated coal gasification black water solution to concentration to obtain a concentrated solution, mixing the concentrated solution and a dispersant, and subjecting a resulting mixture to attrition and magnetic separation in sequence to obtain a magnetically separated suspension;
adjusting the magnetically separated suspension to be alkaline, and subjecting a resulting system to aging and sieving in sequence to obtain a refined slurry; and
mixing the refined slurry, a rubber emulsion, and a flocculant and conducting flocculation copolymerization to obtain the rubber composite material.

In some embodiments, the concentrated solution has a mass concentration of 15% to 45%;
the dispersant includes at least one selected from the group consisting of sodium polyacrylate, sodium stearate, sodium hexametaphosphate, sodium tripolyphosphate, and sodium citrate; and
a mass of the dispersant is 0.3% to 5.5% of a dry matrix mass of the concentrated solution. In some embodiments, the attrition is conducted for 10 min to 120 min.

In some embodiments, the magnetic separation is conducted at an intensity of 800 gauss to 1,600 gauss for 1 min to 3 min.

In some embodiments, a pH of the alkaline is in a range of 8.5 to 11.0; and

the aging is conducted at a temperature of 35° C. to 65° C. under stirring for 0.5 h to 1.5 h.

In some embodiments, solid particles in the refined slurry have a particle size D90 of 2 μm to 18 μm.

In some embodiments, the rubber emulsion includes at least one selected from the group consisting of styrene-butadiene rubber latex, natural rubber latex, and nitrile rubber latex;
the rubber emulsion has a mass concentration of 40% to 69%; and
a mass ratio of a dry matrix of the refined slurry to solids in the rubber emulsion is in a range of 1:1.5 to 1:10.

In some embodiments, the flocculant includes at least one selected from the group consisting of MgCl₂, Mg(NO₃)₂, H₂SO₄, Mg(CH₃COO)₂, Al₂(SO₄)₃, and KAl(SO₄)₂; and
the flocculant is mixed in a form of a flocculant solution, where the flocculant solution has a mass concentration of 15% to 20%.

In some embodiments, the flocculation copolymerization is conducted at a temperature of 35° C. to 70° C. under stirring.

In some embodiments, the method further includes after the flocculation copolymerization, subjecting a resulting material to compounding and vulcanization in sequence.

The present disclosure provides a method for preparing a rubber composite material, including the following steps: subjecting a flocculated coal gasification black water solution to concentration to obtain a concentrated solution, mixing the concentrated solution and a dispersant, and subjecting a resulting mixture to attrition and magnetic separation in sequence to obtain a magnetically separated suspension; adjusting the magnetically separated suspension to be alkaline, and subjecting a resulting system to aging and sieving in sequence to obtain a refined slurry; and mixing the refined slurry, a rubber emulsion, and a flocculant and conducting flocculation copolymerization to obtain the rubber composite material.

The method according to the present disclosure innovatively starts from the upstream stage of coal gasification fine slag, i.e., the coal gasification black water slurry, which is used as a liquid feedstock for direct functional modification. The functionalized liquid feedstock is then combined with a rubber emulsion to prepare a powdered rubber material through emulsion co-coagulation. The method enables water content in the coal gasification black water slurry to be fully utilized, avoiding the centrifugal dewatering and direct drying of coal gasification fine slag. In the method, the functionalized treatment of coal gasification fine slag is integrated with the powdered rubber preparation, offering advantages such as a simplified process flow, low production energy consumption, and being water-saving and environmentally friendly.

### BRIEF DESCRIPTION OF THE DRAWINGS

FIG. 1 shows a schematic flowchart of the method according to an embodiment of the present disclosure;

FIG. 2 shows a particle size distribution diagram of particles in the raw flocculated coal gasification black water solution according to an embodiment of the present disclosure;

FIG. 3 shows a particle size distribution diagram of particles in the concentrated coal gasification black water solution after attrition obtained in Example 1;

FIG. 4 shows a particle size distribution diagram of particles in the concentrated coal gasification black water solution after attrition obtained in Example 2;

FIG. 5 shows a particle size distribution diagram of particles in the concentrated coal gasification black water solution after attrition obtained in Example 3;

FIG. 6 shows a particle size distribution diagram of particles in the concentrated coal gasification black water solution after attrition obtained in Example 4;

FIG. 7 shows a particle size distribution diagram of particles in the concentrated coal gasification black water solution after attrition obtained in Example 5;

FIG. 8 shows a particle size distribution diagram of particles in the concentrated coal gasification black water solution after attrition obtained in Example 6;

FIG. 9 shows a particle size distribution diagram of particles in the concentrated coal gasification black water solution after attrition obtained in Comparative example 1;

FIG. 10 shows a particle size distribution diagram of particles in the concentrated coal gasification black water solution after attrition obtained in Comparative example 2;

FIG. 11 shows a particle size distribution diagram of particles in the concentrated coal gasification black water solution after attrition obtained in Comparative example 3;

FIG. 12 shows an actual image of the rubber composite powder obtained in Example 6;

FIG. 13A shows an actual image (pant-shaped sample) of the rubber composite material obtained in Example 6, and FIG. 13B shows an actual image (dumbbell-shaped sample) of the rubber composite material obtained in Example 6;

FIG. 14A shows a SEM (scanning electron microscope) image (scale: 10 μm) of the rubber composite material obtained in Example 6, and FIG. 14B shows a SEM image (scale: 5 μm) of the rubber composite material obtained in Example 6;

FIG. 15A shows a TEM (transmission electron microscope) image (scale: 0.5 μm) of the rubber composite material obtained in Example 6, and FIG. 15B shows a TEM image (scale: 1 μm) of the rubber composite material obtained in Example 6; and

FIG. 16A shows a SEM image (scale: 20 μm) of the rubber composite powder obtained in Comparative example 1, and FIG. 16B shows a SEM image (scale: 10 μm) of the rubber composite powder obtained in Comparative example 1.

### DETAILED DESCRIPTION OF THE EMBODIMENTS

The present disclosure provides a method for preparing a rubber composite material, including the following steps:
subjecting a flocculated coal gasification black water solution to concentration to obtain a concentrated solution, mixing the concentrated solution and a dispersant, and subjecting a resulting mixture to attrition and magnetic separation in sequence to obtain a magnetically separated suspension;
adjusting the magnetically separated suspension to be alkaline, and subjecting a resulting system to aging and sieving in sequence to obtain a refined slurry; and
mixing the refined slurry, a rubber emulsion, and a flocculant and conducting flocculation copolymerization to obtain the rubber composite material.

In the present disclosure, a flocculated coal gasification black water solution is subjected to concentration to obtain a concentrated solution, the concentrated solution is mixed with a dispersant, and a resulting mixture is subjected to attrition and magnetic separation in sequence to obtain a magnetically separated suspension.

In some embodiments of the present disclosure, the concentrated solution has a mass concentration of 15% to 45%. In some embodiments of the present disclosure, the concentration is conducted by a process including subjecting the flocculated coal gasification black water solution to homogenization and dispersion, and subjecting a resulting system to settling and concentration. In some embodiments of the present disclosure, the flocculated coal gasification black water solution has a mass concentration of 5% to 10%. The source of the flocculated coal gasification black water solution is not specifically limited in the present disclosure, and any source that is well known to the skilled in the art may be used. The processes of homogenization and dispersion and settling and concentration are not specifically limited in the present disclosure, and those that are well known to the skilled in the art may be used.

In some embodiments of the present disclosure, the dispersant includes at least one selected from the group consisting of sodium polyacrylate, sodium stearate, sodium hexametaphosphate, sodium tripolyphosphate, and sodium citrate; and a mass of the dispersant is 0.3% to 5.5% of a dry matrix mass of the concentrated solution. In some embodiments of the present disclosure, the mixing is conducted under stirring for 20 min to 30 min.

In some embodiments of the present disclosure, the attrition is conducted for 10 min to 120 min, preferably 30 min to 90 min. In some embodiments of the present disclosure, the attrition is conducted in a wet vertical stirred mill. In some embodiments of the present disclosure, after the attrition, solid particles in a resulting slurry have a particle size D90 of 5 μm to 18 μm, and a particle size D50 of 2 μm to 6 μm; where D90 represents the particle diameter below which 90% of the sample's particles are smaller (i.e. the particle size at the 90th percentile of the cumulative distribution), and D50 represents the median particle size, meaning 50% of particles are smaller than this diameter and 50% are large.

In some embodiments of the present disclosure, the magnetic separation is conducted at an intensity of 800 gauss to 1,600 gauss, preferably 1,000 gauss to 1,200 gauss, for 1 min to 3 min. In some embodiments of the present disclosure, the magnetic separation is conducted in a high-gradient magnetic separator.

In the present disclosure, after obtaining the magnetically separated suspension, the magnetically separated suspension is adjusted to be alkaline, and a resulting system is subjected to aging and sieving in sequence to obtain a refined slurry.

In some embodiments of the present disclosure, a pH of the alkaline is in a range of 8.5 to 11.0, preferably 9 to 10. The process for adjusting is not specifically limited in the present disclosure, and any process for adjusting to be alkaline that is well known to the skilled in the art may be used.

In some embodiments of the present disclosure, the aging is conducted at a temperature of 35° C. to 65° C. under stirring for 0.5 h to 1.5 h.

The process for sieving is not specifically limited in the present disclosure, and any sieving process that is well known to the skilled in the art may be used. In some embodiments of the present disclosure, solid particles in the refined slurry have a particle size D90 of 2 μm to 18 μm. In some embodiments of the present disclosure, the refined slurry has a mass concentration of 20% to 35%.

In the present disclosure, after obtaining the refined slurry, the refined slurry, a rubber emulsion, and a flocculant are mixed and then subjected to flocculation copolymerization to obtain the rubber composite material.

In some embodiments of the present disclosure, the rubber emulsion includes at least one selected from the group consisting of styrene-butadiene rubber latex, natural rubber latex, and nitrile rubber latex. In some embodiments of the present disclosure, the rubber emulsion has a mass concentration of 40% to 69%, preferably 40% to 50%. In some embodiments of the present disclosure, a mass ratio of a dry matrix in the refined slurry to solids in the rubber emulsion is in a range of 1:1.5 to 1:10.

In some embodiments of the present disclosure, the flocculant includes at least one selected from the group consisting of MgCl₂, Mg(NO₃)₂, H₂SO₄, Mg(CH₃COO)₂, Al₂(SO₄)₃, and KAl(SO₄)₂; and the flocculant is mixed in a form of a flocculant solution, where the flocculant solution has a mass concentration of 15% to 20%. The mass of the flocculant is not specifically limited in the present disclosure, as long as complete flocculation could be achieved.

In some embodiments of the present disclosure, the flocculation copolymerization is conducted at a temperature of 35° C. to 70° C. under stirring. In the present disclosure, the duration of the flocculation copolymerization is not specifically limited and may continue until flocculation is complete.

In some embodiments of the present disclosure, the method further includes after the flocculation copolymerization, subjecting a resulting material to compounding and vulcanization in sequence. The processes for compounding and vulcanization are not specifically limited in the present disclosure, and those that are well known to the skilled in the art may be used.

In some embodiments of the present disclosure, after flocculation copolymerization and before compounding, the resulting material is subjected to dewatering, washing, drying, and crushing in sequence. The processes for dewatering, washing, drying, and crushing are not specifically limited in the present disclosure, and those that are well known to the skilled in the art may be used.

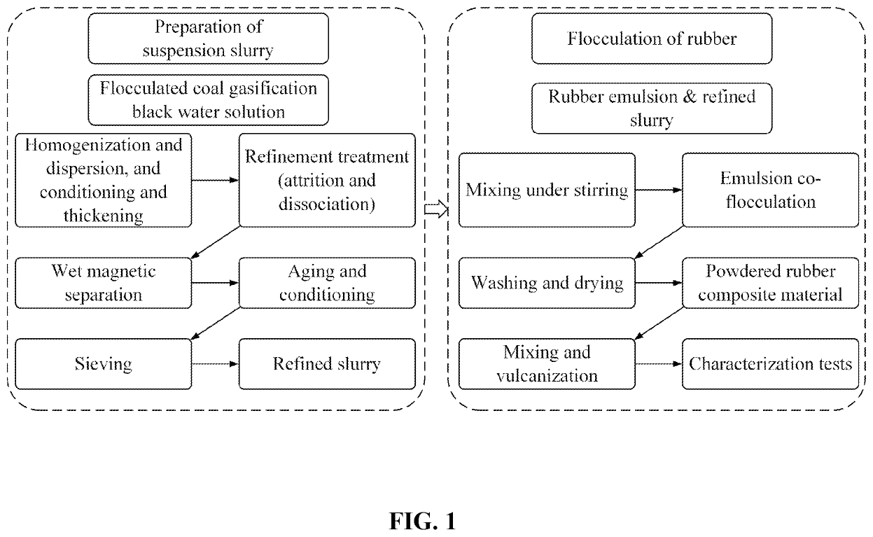

FIG. 1 shows a schematic flowchart of the method according to an embodiment of the present disclosure.

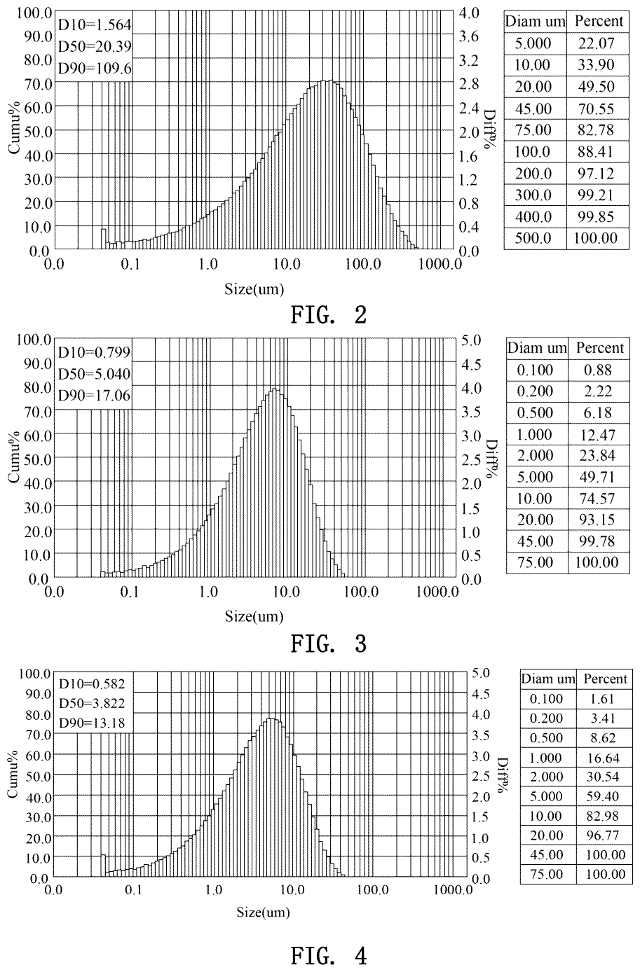

FIG. 2 shows a particle size distribution diagram of an original sample of a flocculated coal gasification black water solution according to an embodiment of the present disclosure. It can be seen from FIG. 2 that the particles in the flocculated coal gasification black water solution have a relatively large particle size and a relatively broad particle size distribution.

In the present disclosure, the particle size distribution is determined using a laser particle size analyzer with ultrasonication, using ethanol as a solution, with a material-to-ethanol mass ratio of 1:5. The measurement is conducted when the refractive index reaches 10 to 12.

In the present disclosure, the cross-sectional morphology image is obtained by adhering a stretched cross-sectional sample of the rubber composite material onto a conductive adhesive, followed by gold sputtering. The morphology and surface element distribution of particles are observed using a field emission electron microscope under conditions as follows: resolution: 2.0 nm (1 kV, WD=1.5 mm, normal mode); magnification: 1,000-50,000×; and electron gun: cold cathode field emission electron source.

In the present disclosure, the transmission electron microscopy imaging conditions are as follows: a maximum magnification: 1.1 million times, and an accelerating voltage: 300 kV; a point resolution: 0.20 nm, a limiting (information) resolution: 0.19 nm, and a minimum beam spot size: 0.2 nm; and the energy resolution of the X-ray energy dispersive spectrometer: 130 eV.

Unless otherwise specified, the materials and equipment used in the present disclosure are commercially available in the art.

The technical solutions in the present disclosure will be described clearly and completely below with reference to the examples of the present disclosure. Apparently, the described examples are merely some, rather than all of the examples of the present disclosure. Based on the examples of the present disclosure, all other examples that can be obtained by those of ordinary skill in the art without inventive efforts shall fall within the scope of the present disclosure.

### Example 1

200 kg of flocculated coal gasification black water solution (with a mass concentration of 7%) from a coal chemical enterprise in Ordos City was selected.

The flocculated coal gasification black water solution was homogenized and dispersed and then settled and concentrated to obtain a concentrated coal gasification black water solution with a mass concentration of 30%.

Sodium polyacrylate, as a dispersant, was added to the concentrated coal gasification black water solution in an amount of 0.5% (0.07 kg) of a dry basis of the concentrated coal gasification black water solution and then vigorously stirred for 20 min. A resulting uniformly mixed slurry was pumped into a wet vertical stirred mill and attrited for 30 min under stirring. After attrition, solid particles in a resulting attrited slurry had a particle size D90 of 17.06 μm and a D50 of 5.04 μm. The resulting attrited slurry was pumped to a high-gradient magnetic separator and subjected to magnetic separation at an intensity of 1,000 gauss for 3 min, resulting in a magnetically separated suspension.

The magnetically separated suspension was adjusted to a pH of 9 and then aged under stirring at 35° C. for 0.5 h. A resulting aged system was then sieved, resulting in 47 kg of a refined slurry, where solid particles in the refined slurry had a particle size D90 of 17.06 μm, and the refined slurry had a mass concentration of 30%.

The refined slurry was pumped into a flocculation mixer, and then 70 kg of a natural rubber emulsion (with a mass concentration of 40%) was added thereto. An Al₂(SO₄)₃ flocculant solution with a mass concentration of 20% was added thereto via a peristaltic pump, and a resulting mixture was subjected to flocculation copolymerization while stirring at 60° C. until the flocculation process was completed. A resulting slurry was filtered and washed with water three times, and then dried and crushed to obtain a rubber composite powder.

The rubber composite powder was compounded and vulcanized in sequence to obtain a rubber composite material.

FIG. 3 shows a particle size distribution diagram of particles in the concentrated coal gasification black water solution after attrition.

### Example 2

200 kg of flocculated coal gasification black water solution (with a mass concentration of 8%) from a coal chemical enterprise in Ordos City was selected.

The flocculated coal gasification black water solution was homogenized and dispersed and then settled and concentrated to obtain a concentrated coal gasification black water solution with a mass concentration of 25%.

Sodium polyacrylate, as a dispersant, was added to the concentrated coal gasification black water solution in an amount of 0.65% (0.104 kg) of a dry basis of the concentrated coal gasification black water solution and then vigorously stirred for 30 min. A resulting uniformly mixed slurry was pumped into a wet vertical stirred mill and attrited for 45 min under stirring. After attrition, solid particles in a resulting attrited slurry had a particle size D90 of 13.18 μm and a D50 of 3.82 μm. The resulting attrited slurry was pumped to a high-gradient magnetic separator and subjected to magnetic separation at an intensity of 1,100 gauss for 2 min, resulting in a magnetically separated suspension.

The magnetically separated suspension was adjusted to a pH of 9 and then aged under stirring at 40° C. for 1 h. A resulting aged system was then sieved, resulting in 64 kg of a refined slurry, where solid particles in the refined slurry had a particle size D90 of 13.18 μm, and the refined slurry had a mass concentration of 25%.

The refined slurry was pumped into a flocculation mixer, and then 72 kg of a natural rubber emulsion (with a mass concentration of 45%) was added thereto. An Al₂(SO₄)₃ flocculant solution with a mass concentration of 20% was added thereto via a peristaltic pump, and a resulting mixture was subjected to flocculation copolymerization while stirring at 60° C. until the flocculation process was completed. A resulting slurry was filtered and washed with water three times, and then dried and crushed to obtain a rubber composite powder.

The rubber composite powder was compounded and vulcanized in sequence to obtain a rubber composite material.

FIG. 4 shows a particle size distribution diagram of particles in the concentrated coal gasification black water solution after attrition.

### Example 3

200 kg of flocculated coal gasification black water solution (with a mass concentration of 10%) from a coal chemical enterprise in Ordos City was selected.

The flocculated coal gasification black water solution was homogenized and dispersed and then settled and concentrated to obtain a concentrated coal gasification black water solution with a mass concentration of 20%.

Sodium polyacrylate, as a dispersant, was added to the concentrated coal gasification black water solution in an amount of 0.65% (0.13 kg) of a dry basis of the concentrated coal gasification black water solution and then vigorously stirred for 30 min. A resulting uniformly mixed slurry was pumped into a wet vertical stirred mill and attrited for 60 min under stirring. After attrition, solid particles in a resulting attrited slurry had a particle size D90 of 11.2 μm and a D50 of 3.71 μm. The resulting attrited slurry was pumped to a high-gradient magnetic separator and subjected to magnetic separation at an intensity of 1,200 gauss for 1.5 min, resulting in a magnetically separated suspension.

The magnetically separated suspension was adjusted to a pH of 9.5 and then aged under stirring at 45° C. for 1.5 h. A resulting aged system was then sieved, resulting in 100 kg of a refined slurry, where solid particles in the refined slurry had a particle size D90 of 11.2 μm, and the refined slurry had a mass concentration of 20%.

The refined slurry was pumped into a flocculation mixer, and then 80 kg of a natural rubber emulsion (with a mass concentration of 50%) was added thereto. An Al₂(SO₄)₃ flocculant solution with a mass concentration of 20% was added thereto via a peristaltic pump, and a resulting mixture was subjected to flocculation copolymerization while stirring at 60° C. until the flocculation process was completed. A resulting slurry was filtered and washed with water three times, and then dried and crushed to obtain a rubber composite powder.

The rubber composite powder was compounded and vulcanized in sequence to obtain a rubber composite material.

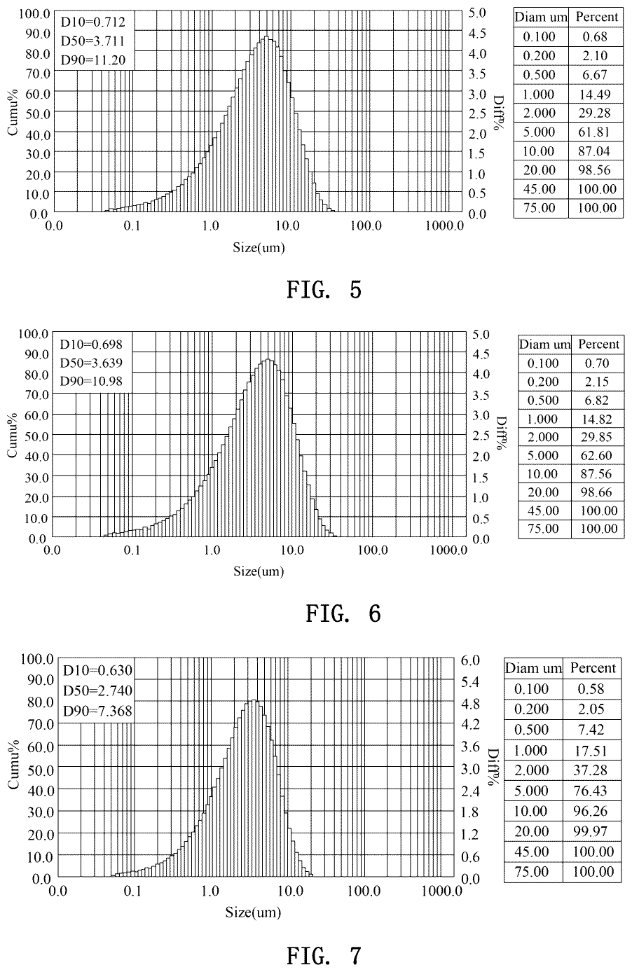

FIG. 5 shows a particle size distribution diagram of particles in the concentrated coal gasification black water solution after attrition.

### Example 4

200 kg of flocculated coal gasification black water solution (with a mass concentration of 7%) from a coal chemical enterprise in Ordos City was selected.

The flocculated coal gasification black water solution was homogenized and dispersed and then settled and concentrated to obtain a concentrated coal gasification black water solution with a mass concentration of 25%.

Sodium polyacrylate, as a dispersant, was added to the concentrated coal gasification black water solution in an amount of 0.7% (0.14 kg) of a dry basis of the concentrated coal gasification black water solution and then vigorously stirred for 30 min. A resulting uniformly mixed slurry was pumped into a wet vertical stirred mill and attrited for 90 min under stirring. After attrition, solid particles in a resulting attrited slurry had a particle size D90 of 10.98 μm and a D50 of 3.64 μm. The resulting attrited slurry was pumped to a high-gradient magnetic separator and subjected to magnetic separation at an intensity of 1,000 gauss for 3 min, resulting in a magnetically separated suspension.

The magnetically separated suspension was adjusted to pH 10 and then aged under stirring at 50° C. for 1.5 h. A resulting aged system was then sieved, resulting in 80 kg of a refined slurry, where solid particles in the refined slurry had a particle size D90 of 10.98 μm, and the refined slurry had a mass concentration of 25%.

The refined slurry was pumped into a flocculation mixer, and then 100 kg of a natural rubber emulsion (with a mass concentration of 40%) was added thereto. An Al₂(SO₄)₃ flocculant solution with a mass concentration of 20% was added thereto via a peristaltic pump, and a resulting mixture was subjected to flocculation copolymerization while stirring at 60° C. until the flocculation process was completed. A resulting slurry was filtered and washed with water three times, and then dried and crushed to obtain a rubber composite powder.

The rubber composite powder was mixed and vulcanized in sequence to obtain a rubber composite material.

FIG. 6 shows a particle size distribution diagram of particles in the concentrated coal gasification black water solution after attrition.

### Example 5

200 kg of flocculated coal gasification black water solution (with a mass concentration of 8%) from a coal chemical enterprise in Ordos City was selected.

The flocculated coal gasification black water solution was homogenized and dispersed and then settled and concentrated to obtain a concentrated coal gasification black water solution with a mass concentration of 30%.

Sodium polyacrylate, as a dispersant, was added to the concentrated coal gasification black water solution in an amount of 0.8% (0.128 kg) of a dry basis of the concentrated coal gasification black water solution and then vigorously stirred for 30 min. A resulting uniformly mixed slurry was pumped into a wet vertical stirred mill and attrited for 90 min under stirring. After attrition, solid particles in a resulting attrited slurry had a particle size D90 of 7.37 μm and a D50 of 2.74 μm. The resulting attrited slurry was pumped to a high-gradient magnetic separator for magnetic separation at an intensity of 1,100 gauss for 1 min, resulting in a magnetically separated suspension.

The magnetically separated suspension was adjusted to a pH of 10 and then aged under stirring at 60° C. for 1 h. A resulting aged system was then sieved, resulting in 54 kg of a refined slurry, where solid particles in the refined slurry had a particle size D90 of 7.37 μm, and the refined slurry had a mass concentration of 30%.

The refined slurry was pumped into a flocculation mixer, and then 71 kg of a natural rubber emulsion (with a mass concentration of 45%) was added thereto. An Al₂(SO₄)₃ flocculant solution with a mass concentration of 20% was added thereto via a peristaltic pump, and a resulting mixture was subjected to flocculation copolymerization while stirring at 60° C. until the flocculation process was completed. A resulting slurry was filtered and washed with water three times, and then dried and crushed to obtain a rubber composite powder.

The rubber composite powder was compounded and vulcanized in sequence to obtain a rubber composite material.

FIG. 7 shows a particle size distribution diagram of particles in the concentrated coal gasification black water solution after attrition.

### Example 6

200 kg of flocculated coal gasification black water solution (with a mass concentration of 7%) from a coal chemical enterprise in Ordos City was selected.

The flocculated coal gasification black water solution was homogenized and dispersed and then settled and concentrated to obtain a concentrated coal gasification black water solution with a mass concentration of 20%.

Sodium polyacrylate, as a dispersant, was added to the concentrated coal gasification black water solution in an amount of 1% (0.14 kg) of a dry basis of the concentrated coal gasification black water solution and then vigorously stirred for 30 min. A resulting uniformly mixed slurry was pumped into a wet vertical stirred mill and attrited for 90 min under stirring. After attrition, solid particles in a resulting attrited slurry had a particle size D90 of 5.61 μm and a D50 of 2.06 μm. The resulting attrited slurry was pumped to a high-gradient magnetic separator for magnetic separation at an intensity of 1,200 gauss for 2 min, resulting in a magnetically separated suspension.

The magnetically separated suspension was adjusted to a pH of 10 and then aged under stirring at 65° C. for 1.5 h. A resulting aged system was then sieved, resulting in 70 kg of a refined slurry, where solid particles in the refined slurry had a particle size D90 of 5.61 μm, and the refined slurry had a mass concentration of 20%.

The refined slurry was pumped into a flocculation mixer, and then 56 kg of a natural rubber emulsion (with a mass concentration of 50%) was added thereto. An Al₂(SO₄)₃ flocculant solution with a mass concentration of 20% was added thereto via a peristaltic pump, and a resulting mixture was subjected to flocculation copolymerization while stirring at 60° C. until the flocculation process was completed. A resulting slurry was filtered and washed with water three times, and then dried and crushed to obtain a rubber composite powder.

The rubber composite powder was compounded and vulcanized in sequence to obtain a rubber composite material.

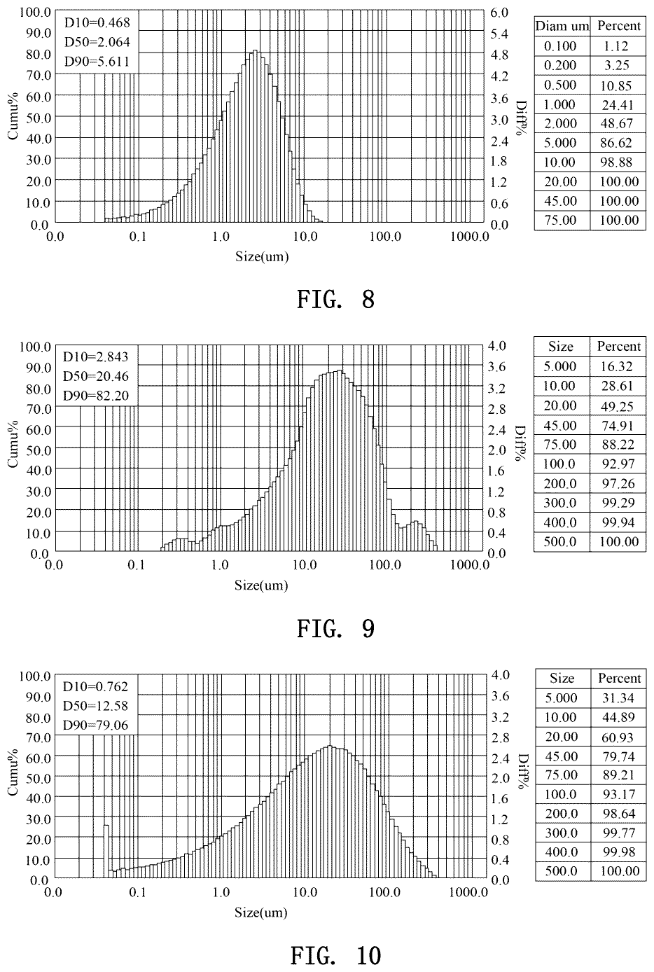

FIG. 8 shows a particle size distribution diagram of particles in a concentrated coal gasification black water solution after attrition.

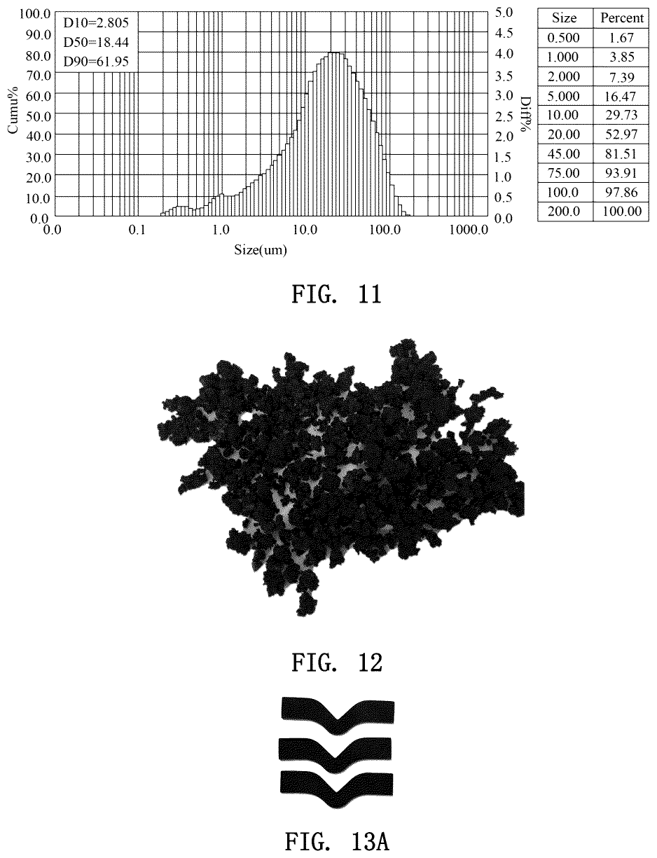

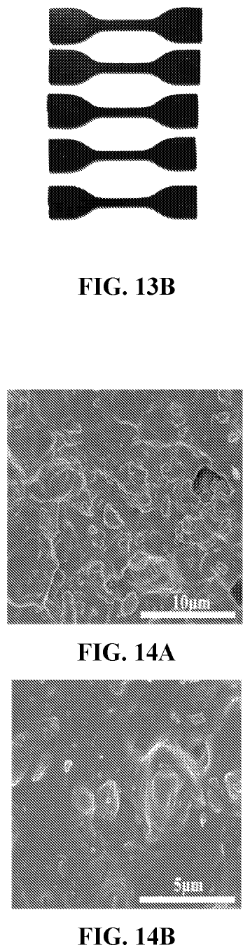

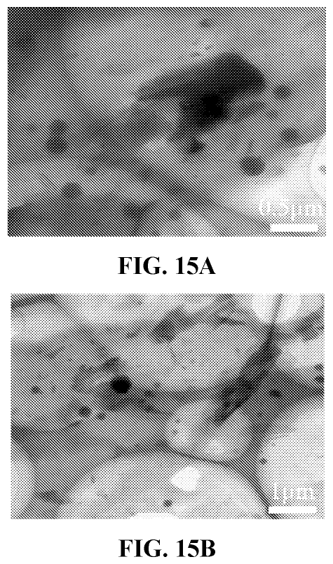

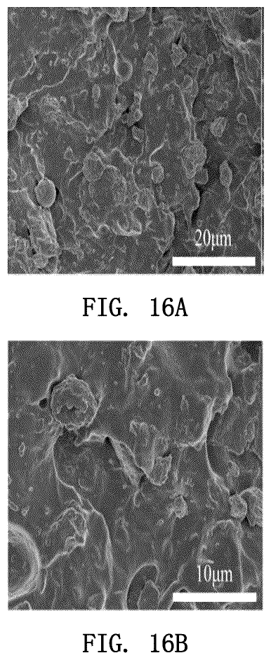

FIG. 12 shows an actual image of the rubber composite powder, FIG. 13A to FIG. 13B show actual images of the rubber composite material obtained after vulcanization, FIG. 14A to FIG. 14B show SEM images of the rubber composite material obtained after vulcanization, and FIG. 15A to FIG. 15B show TEM images of the rubber composite material obtained after vulcanization. As can be seen from FIG. 12 and FIGS. 13A-15B, the coal gasification fine slag is relatively evenly distributed in the powdered rubber, with no significant agglomeration, and exhibits good compatibility with the rubber matrix.

### Comparative Example 1

200 kg of flocculated coal gasification black water solution (with a mass concentration of 7.5%) from a coal chemical enterprise in Ordos City was selected.

The flocculated coal gasification black water solution was homogenized and dispersed and then settled and concentrated to obtain a concentrated coal gasification black water solution with a mass concentration of 40%.

Sodium polyacrylate, as a dispersant, was added to the concentrated coal gasification black water solution in an amount of 2% (0.3 kg) of a dry basis of the concentrated coal gasification black water solution and then vigorously stirred for 40 min. A resulting uniformly mixed slurry was pumped into a wet vertical stirred mill and attrited for 3 min under stirring. After attrition, solid particles in a resulting attrited slurry had a particle size D90 of 82.2 μm. The resulting attrited slurry was pumped to a high-gradient magnetic separator and subjected to magnetic separation at an intensity of 850 gauss for 3 min, resulting in a magnetically separated suspension.

The magnetically separated suspension was adjusted to a pH of 11 and then aged under stirring at 35° C. for 0.5 h. A supernatant of a resulting aged system was then poured to obtain 37.5 kg of a refined slurry, where solid particles in the refined slurry had a particle size D90 of 82.2 μm, and the refined slurry had a mass concentration of 40%.

The refined slurry was pumped into a flocculation mixer, and then 67 kg of a natural rubber emulsion (with a mass concentration of 45%) was added thereto. An Al₂(SO₄)₃ flocculant solution with a mass concentration of 25% was added thereto via a peristaltic pump, and a resulting mixture was subjected to flocculation copolymerization while stirring at 60° C. until the flocculation process was completed. A resulting slurry was filtered and washed with water three times, and then dried and crushed to obtain a rubber composite powder.

The rubber composite powder was compounded and vulcanized in sequence to obtain a rubber composite material.

FIG. 9 shows a particle size distribution diagram of particles in the concentrated coal gasification black water solution after attrition.

FIG. 16A to FIG. 16B show SEM images of the obtained rubber composite powder. As can be seen from the cross-sectional morphology of the coal gasification slag rubber composite material shown in FIG. 16A to FIG. 16B, due to the large particle size, the surface bonding ability is low, and the bonding ability with rubber is poor.

### Comparative Example 2

200 kg of flocculated coal gasification black water solution (with a mass concentration of 7%) from a coal chemical enterprise in Ordos City was selected.

The flocculated coal gasification black water solution was homogenized and dispersed and then settled and concentrated to obtain a concentrated coal gasification black water solution with a mass concentration of 20%.

Sodium polyacrylate, as a dispersant, was added to the concentrated coal gasification black water solution in an amount of 0.5% (0.07 kg) of a dry basis of the concentrated coal gasification black water solution and then vigorously stirred for 20 min. A resulting uniformly mixed slurry was pumped into a wet vertical stirred mill and attrited for 5 min under stirring. After attrition, solid particles in a resulting attrited slurry had a particle size D90 of 79.06 μm. The resulting attrited slurry was pumped to a high-gradient magnetic separator and subjected to magnetic separation at an intensity of 900 gauss for 3 min, resulting in a magnetically separated suspension.

The magnetically separated suspension was adjusted to a pH of 8 and then aged under stirring at 40° C. for 1.5 h. A resulting aged system was then sieved, resulting in 70 kg of a refined slurry, where solid particles in the refined slurry had a particle size D90 of 79.06 μm, and the refined slurry had a mass concentration of 20%.

The refined slurry was pumped into a flocculation mixer, and then 56 kg of a natural rubber emulsion (with a mass concentration of 50%) was added thereto. An Al₂(SO₄)₃ flocculant solution with a mass concentration of 20% was added thereto via a peristaltic pump, and a resulting mixture was subjected to flocculation copolymerization while stirring at 60° C. until the flocculation process was completed. A resulting slurry was filtered and washed with water three times, and then dried and crushed to obtain a rubber composite powder.

The rubber composite powder was mixed and vulcanized in sequence to obtain a rubber composite material.

FIG. 10 shows a particle size distribution diagram of particles in the concentrated coal gasification black water solution after attrition.

### Comparative Example 3

200 kg of flocculated coal gasification black water solution (with a mass concentration of 8%) from a coal chemical enterprise in Ordos City was selected.

The flocculated coal gasification black water solution was homogenized and dispersed and then settled and concentrated to obtain a concentrated coal gasification black water solution with a mass concentration of 50%.

Sodium polyacrylate, as a dispersant, was added to the concentrated coal gasification black water solution in an amount of 0.5% (0.08 kg) of a dry basis of the concentrated coal gasification black water solution and then vigorously stirred for 20 min. A resulting uniformly mixed slurry was pumped into a wet vertical stirred mill and attrited for 120 min under stirring. After attrition, solid particles in a resulting attrited slurry had a particle size D90 of 61.95 μm. The resulting attrited slurry was pumped to a high-gradient magnetic separator and subjected to magnetic separation at an intensity of 1500 gauss for 3 min, resulting in a magnetically separated suspension.

The magnetically separated suspension was adjusted to a pH of 10 and then aged under stirring at 50° C. for 1.5 h. A resulting aged system was then sieved, resulting in 32 kg of a refined slurry, where solid particles in the refined slurry had a particle size D90 of 61.95 μm, and the refined slurry had a mass concentration of 50%.

The refined slurry was pumped into a flocculation mixer, and then 64 kg of a natural rubber emulsion (with a mass concentration of 50%) was added thereto. An Al₂(SO₄)₃ flocculant solution with a mass concentration of 20% was added thereto via a peristaltic pump, and a resulting mixture was subjected to flocculation copolymerization while stirring at 60° C. until the flocculation process was completed. A resulting slurry was filtered and washed with water three times, and then dried and crushed to obtain a rubber composite powder.

The rubber composite powder was mixed and vulcanized in sequence to obtain a rubber composite material.

FIG. 11 shows a particle size distribution diagram of particles in the concentrated coal gasification black water solution after attrition.

### Performance Tests

The mechanical properties of the rubber composite materials obtained in Examples 1-6 and Comparative examples 1-3 were tested. The tensile strength was measured in accordance with the GB/T 531-99 testing standard, the tear strength was determined following the GB/T 529-99 testing standard, the modulus was assessed as per the GB/T 531-99 testing standard, and the elongation at break was evaluated according to the GB/T 531-99 testing standard.

The test results are as shown in Table 1.

Table 1 Mechanical properties of rubber composite materials obtained in Examples 1-6 and Comparative examples 1-3

| | Tensile | Tear | Modulus/MPa | | | Elongation at |
|---|---|---|---|---|---|---|
| | strength/MPa | strength/(KN/m) | 100% | 300% | 500% | break/% |
| Example 1 | 7.59 ± 0.085 | 49.18 ± 2.508 | 0.98 ± 0.75 | 1.30 ± 0.076 | 2.42 ± 0.217 | 1023.60 ± 105.3 |
| Example 2 | 8.2 ± 0.468 | 49.32 ± 2.164 | 1.02 ± 0.06 | 1.34 ± 0.137 | 2.5 ± 0.409 | 1160.21 ± 157.0 |
| Example 3 | 10.49 ± 0.231 | 45.97 ± 2.456 | 1.14 ± 0.05 | 1.60 ± 0.123 | 2.55 ± 0.258 | 1244.94 ± 112.5 |
| Example 4 | 10.51 ± 0.256 | 44.95 ± 1.873 | 1.15 ± 0.05 | 1.62 ± 0.093 | 2.76 ± 0.259 | 1390.43 ± 121.8 |
| Example 5 | 10.91 ± 1.877 | 49.01 ± 6.341 | 1.17 ± 0.07 | 2.05 ± 0.185 | 3.48 ± 0.483 | 1430.84 ± 144.3 |
| Example 6 | 10.94 ± 1.275 | 46.58 ± 6.56 | 1.25 ± 0.1 | 1.72 ± 0.17 | 3.85 ± 0.48 | 1516.34 ± 212.5 |
| Comparative | 5.68 ± 1.375 | 26.48 ± 3.65 | 0.77 ± 0.3 | 1.05 ± 0.23 | 2.08 ± 0.48 | 985.23 ± 112.52 |
| example 1 | | | | | | |
| Comparative | 5.93 ± 1.256 | 27.01 ± 4.35 | 0.85 ± 0.05 | 1.12 ± 0.12 | 2.09 ± 0.483 | 896.30 ± 144.02 |
| example 2 | | | | | | |
| Comparative | 6.36 ± 0.368 | 27.35 ± 5.32 | 0.96 ± 0.02 | 1.24 ± 0.032 | 2.11 ± 0.25 | 1000.84 ± 132.25 |
| example 3 | | | | | | |

From Table 1, it can be seen that the mechanical properties of Examples 1 to 6 exhibit a correlation with the particle size in the examples. The smaller the particle size, the better the mechanical properties.

Although the examples described above have provided a detailed description of the present disclosure, they are only a part of, rather than all of the embodiments of the present disclosure. All other embodiments that can be obtained according to the embodiments of the present disclosure without inventive efforts shall fall within the scope of the disclosure.

What is claimed is:

1. A method for preparing a rubber composite material, comprising:
subjecting a flocculated coal gasification black water solution to concentration to obtain a concentrated solution, mixing the concentrated solution and a dispersant, and subjecting a resulting mixture to attrition and magnetic separation in sequence to obtain a magnetically separated suspension;
adjusting the magnetically separated suspension to be alkaline, and subjecting a resulting system to aging and sieving in sequence to obtain a refined slurry; and
mixing the refined slurry, a rubber emulsion, and a flocculant and conducting flocculation copolymerization to obtain the rubber composite material.

2. The method of claim 1, wherein the concentrated solution has a mass concentration of 15% to 45%;
the dispersant comprises at least one selected from the group consisting of sodium polyacrylate, sodium stearate, sodium hexametaphosphate, sodium tripolyphosphate, and sodium citrate; and
a mass of the dispersant is 0.3% to 5.5% of a dry matrix mass of the concentrated solution.

3. The method of claim 1, wherein the attrition is conducted for 10 minutes to 120 minutes.

4. The method of claim 1, wherein the magnetic separation is conducted at an intensity of 800 gauss to 1,600 gauss for 1 minute to 3 minutes.

5. The method of claim 1, wherein a pH of the alkaline is in a range of 8.5 to 11.0; and
the aging is conducted at a temperature of 35° C. to 65° C. under stirring for 0.5 hours to 1.5 hours.

6. The method of claim 1, wherein solid particles in the refined slurry have a particle size D90 of 2 μm to 18 μm.

7. The method of claim 1, wherein the rubber emulsion comprises at least one selected from the group consisting of styrene-butadiene rubber latex, natural rubber latex, and nitrile rubber latex;
the rubber emulsion has a mass concentration of 40% to 69%; and
a mass ratio of a dry matrix in the refined slurry to solids in the rubber emulsion is in a range of 1:1.5 to 1:10.

8. The method of claim 1, wherein the flocculant comprises at least one selected from the group consisting of MgCl₂, Mg(NO₃)₂, H₂SO₄, Mg(CH₃COO)₂, Al₂(SO₄)₃, and KAl(SO₄)₂; and
the flocculant is mixed in a form of a flocculant solution, wherein the flocculant solution has a mass concentration of 15% to 20%.

9. The method of claim 1, wherein the flocculation copolymerization is conducted at a temperature of 35° C. to 70° C. under stirring.

10. The method of claim 1, wherein the method further comprises after the flocculation copolymerization, subjecting a resulting material to compounding and vulcanization in sequence.

11. The method of claim 5, wherein solid particles in the refined slurry have a particle size D90 of 2 μm to 18 μm.
